(19) United States
(12) Patent Application Publication
(10) Pub. No.: US 2011/0047581 A1
(43) Pub. Date: Feb. 24, 2011

(54) APPARATUS AND METHOD FOR A HOME COMMUNICATION CENTER

(76) Inventors: Ram Caspi, Sunnyvale, CA (US); Jeffrey M. Blohm, Portola Valley, CA (US); John Yates, Mountain View, CA (US); Tom Miller, Los Altos, CA (US); David Winikoff, Menio Park, CA (US)

Correspondence Address: Ram Caspi, 1420 Kingfisher Way, Sunnyvale, CA, 94087, US

(21) Appl. No.: 12/859,244

(22) Filed: Aug. 18, 2010

Related U.S. Application Data
(60) Provisional application No. 61/235,341, filed on Aug. 19, 2009.

(51) Int. Cl. H04N 7/18

(52) U.S. Cl. 725/80

(57) ABSTRACT

Embodiments of the invention provide a home communications device. The home communications device is connected to an external network comprising external devices. The home communications device comprises a plurality of interfaces for connecting a plurality of internal devices to form one or more internal networks. The home communications device further comprises a communication manager configured to enable communication among one or more of the internal devices and the external devices, wherein one or more of the internal devices operate on separate or similar communication protocols.

### CROSS REFERENCE TO RELATED APPLICATIONS

This application is a Non-Provisional application of a U.S. Provisional Application Ser. No. 61/235,341 entitled ‘Residential Communications Hub on a DVR or Set-Top Box’ and filed on Aug. 19, 2009. The entire teachings of the above application are incorporated herein by reference.

### FIELD OF THE INVENTION

The invention relates to communication management and more specifically the invention relates to apparatus and method for a home communication center.

### BACKGROUND OF THE INVENTION

Various services such as broadband Internet access, television (TV) signals and telephony can be provided over a single network connection. Generally, such a service is known as a triple play service. Further, quadruple play services are also available that additionally provide mobility options such as through wireless or mobile connectivity. The services are generally enabled by providing devices such as a Set-Top-Box (STB), a Digital-Video-Recorder (DVR), a home media gateway, a media streaming box and so forth at a customer's premises. In recent years, a new capability has been added to the STBs, which allows the customer to record TV programming on a Hard Disk Drive (HDD), a Solid State Drive (SSD) or network backend storage such as network Digital Video Recorder (DVR), and play it back later, without the need for a recording media such as video cassettes. Typically, these STBs are powerful computer systems with a form factor of an STB, which is connected to the customer's devices such as a TV, a home theater system, telephones and so forth.

The three services may be delivered by a single service provider and paid for using a single billing account. However, these services are offered as separate entities. For example, the TV connectivity is independent of the telephone or the broadband Internet services.

In light of the above discussion techniques are desirable to provide a home communications center.

### SUMMARY

The present invention provides a home communications device connected to an external network. The external network comprises one or more external devices. The home communications device comprising: a plurality of interfaces for connecting the home communications device to a plurality of internal devices to form one or more internal networks; and a communication manager configured to enable communication among a plurality of the internal devices and the external devices, wherein one or more of the internal devices operate on separate communication protocols.

The present invention further provides a method for managing communications at a home communications device, wherein it is connected to an external network and an internal network. The method comprising: receiving a first request for communication at the home communications device; and connecting, by the home communications device, one or more external devices to one or more internal devices for communication based on the request and one or more predefined preferences, wherein the internal devices are connected to the internal network and the external devices are connected to the external network, and wherein one or more of the internal devices operate on separate communication protocols. Other combinations of external and internal devices are also possible, such as connecting two external devices or two internal devices or any combination of external and internal devices.

The present invention further provides a computer program product comprising instructions executable by a processor for performing a method for managing communications at a home communications device, wherein it is connected to an external network and an internal network. The method comprising: receiving a first request for communication at the home communications device; and connecting, by the home communications device, one or more external devices to one or more internal devices for communication based on the request and one or more predefined preferences, wherein the internal devices are connected to the internal network and the external devices are connected to the external network, and wherein one or more of the internal devices operate on separate communication protocols. Other combinations of external and internal devices are also possible, such as connecting two external devices or two internal devices or any combination of external and internal devices.

An aspect of the invention is to provide a home communications or combined interface for telephony lines such as Public Switched Telephone Network (PSTN), Voice over Internet Protocol (VOIP) and cellular connections based on predefined preferences and set of predefined rules.

### BRIEF DESCRIPTION OF THE DRAWINGS

Having thus described the invention in general terms, reference will now be made to the accompanying drawings, which are not necessarily drawn to scale, and wherein:

FIG. 1 illustrates an environment where various embodiments of the present invention function, in accordance with an embodiment of the invention;

FIG. 2 illustrates elements of a home communications device, in accordance with an embodiment of the invention;

FIG. 3 illustrates elements of a communication manager, in accordance with an embodiment of the invention;

FIG. 4 is a flowchart for managing a request for communication, in accordance with an embodiment of the invention;

FIG. 5 is a flowchart for managing a request for communication sent by an internal device, in accordance with an embodiment of the invention;

FIG. 6 is a flowchart for managing requests for communication sent by an internal device, in accordance with another embodiment of the invention.

FIG. 7 illustrates an exemplary residential implementation of the home communications device;

FIG. 8 illustrates an exemplary functional implementation of the home communications device; and

FIG. 9 illustrates another exemplary residential implementation of the home communications device.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

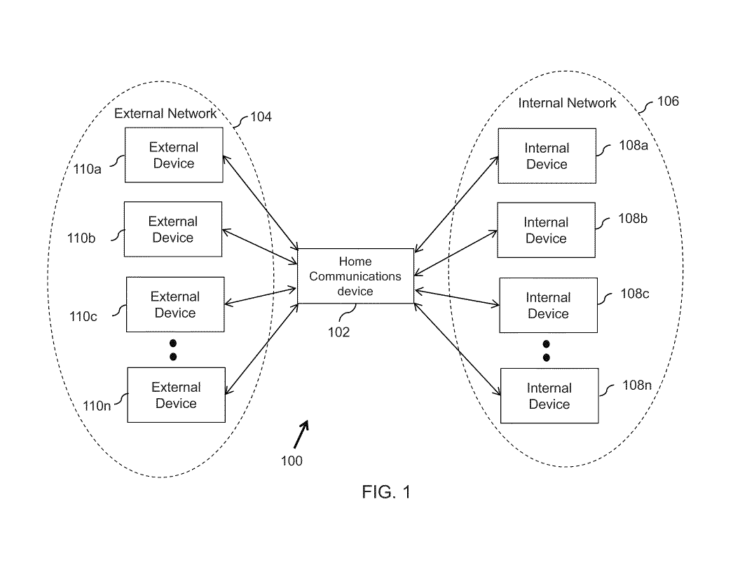

With reference to FIG. 1 an environment 100 is illustrated where various embodiments of the present invention function, in accordance with an embodiment of the invention. Typically, the communication between various devices may be performed by using various media types. Examples of media types include, voice, data and video. Therefore, a user of a device may communicate with another user on another device by exchanging information in any media type. A home communications device 102 enables the user to communicate by using any or all of the media types or communication protocols. Examples of home communications device 102 include, but are not limited to, a Digital Video Recorder (DVR), a set-top box, a home media gateway, a media streaming device, an Integrated Access Device (IAD), a blu-ray player, a smart television and so forth.

Home communications device 102 is connected to an external network 104 and an internal network 106. Examples of external network 104 include, but are not limited to the Internet, high bandwidth computer network, a cable TV infrastructure, a satellite infrastructure such as a Direct-Broadcast Satellite (DBS) and so forth. Further, examples of internal network 106 include a Local Area Network (LAN), a wireless network, a mobile network, a Personal Area Network (PAN) such as Bluetooth and so forth.

External network 104 includes multiple external devices 110a-n that can communicate with home communications device 102. Moreover, external devices 110a-n can communicate with multiple internal devices 108a-n connected to internal network 106 or with other external devices via the home communications device. Further, internal devices 108a-n can communicate among each other directly or through home communications device 102. Examples of external devices 110a-n and internal device 108a-n include, but are not limited to, telephones, computers, laptops, tablet computers, mobile phones, televisions, home theatre systems, gaming consoles, and so forth. Moreover, home communications device 102 may support various communication protocols such as Voice Over Internet Protocol (VOIP) such as Session Initiation Protocol (SIP), Media Gateway Control Protocol (MGCP) and H.323, radio telecommunication and so forth.

Home communications device 102 manages the communication among external devices 110a-n and internal devices 108a-n based on predefined preference. The predefined preferences include rules that can be configured by the user of home communications device 102 to manage calls. Therefore, for instance, when a call is received at home communications device 102 from an external device 110a using VOIP, then the call may be forwarded or routed to an internal device 108a such as an ordinary telephone based on the predefined preferences available at home communications device 102. In this case, home communications device 102 may format the VOIP communication to support the analog communication of the ordinary telephone or can use another device such as an Analog Telephone Adaptor (ATA/IAD) to communicate with ordinary analog phone(s) and vice versa.

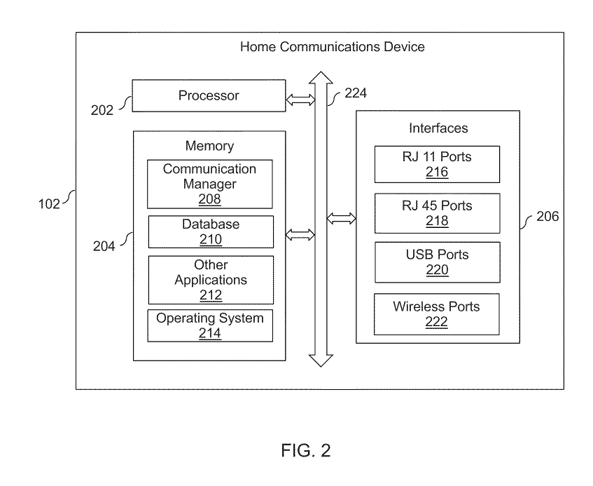

With reference to FIG. 2 exemplary elements of home communications device 102 for managing communications are illustrated. Home communications device 102 includes a processor 202, a memory 204 and multiple interfaces 206. Although not shown, a person skilled in the art will appreciate that various other components may be present in home communications devices 102 such as a power source. As shown, interfaces 206 include various ports such as Registered Jack (RJ) 11 ports 216, RJ 45 LAN ports 218, Universal Serial Bus (USB) ports 220 and wireless ports 222 such as Bluetooth. RJ 11 ports 216 may be used to connect telephony devices such as ordinary telephone systems. Similarly, RJ 45 ports may be used to connect devices that support data transfer through Ethernet. Wireless ports 222 may provide connectivity through protocols such as Bluetooth, Infrared, Wi-Fi and so forth. Therefore, as shown home communications device 102 may be connected to various types of devices supporting separate and/or multiple communication protocols. A person skilled in the art will appreciate that other communication protocols can be supported in a similar manner by the addition of more interface modules.

Memory 204 includes an Operating System (OS) 214, other applications 212, a database 210, and a communication manager 208. Examples of memory 204 include, but are not limited to, a Read Only Memory (ROM), a Random Access Memory (RAM), a hard disk, flash memory or other computer readable media capable of storing instructions that can be executed by processor 202. Communication manager 208 includes instructions that can be executed by processor 202 to manage communication between devices. Further, communication manager 208 may include the predefined preferences in the form of a rule engine. The database 210 includes information regarding the communication. For example, database 210 may include contact information, usage statistics, user information, predefined user rules, log and trace files, data such as voicemail, email, and so forth. Processor 202, memory 204 and interfaces 206 are connected through a system bus 224. Communication manager 208 may be implemented as hardware, software, firmware or a combination of these in home communications device 102.

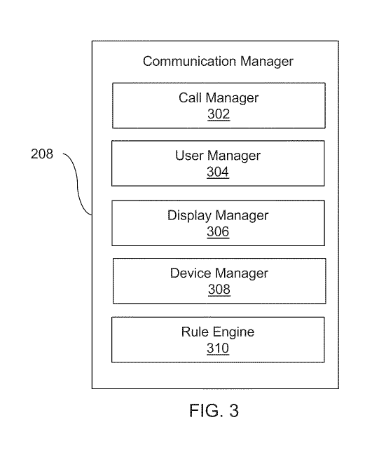

FIG. 3 illustrates exemplary elements of communication manager 208, in accordance with an embodiment of the invention. As discussed above, communication manager 208 manages the communication through home communications device 102. Communications manager 208 includes a call manager 302 for managing calls through home communications device 102. In an embodiment of the invention, call manager 302 may be implemented as an enhanced Private Branch Exchange (PBX) for managing the communications. It provides all call control features (such as hold, forward, transfer, consult, add party, disconnect, etc.) and unified communications features. Further, call manager 302 may provide a unified interface for Public Switched Telephone Network (PSTN) lines, VOIP lines and cellular telephony. Moreover, call manager 302 can manage separate communication protocols such as Internet Protocol, Real-time Transport Protocol, Digital Enhanced Cordless Telecommunications, and radio telecommunication such as Bluetooth profiles support (headset and hands-free among others).

An exemplary processing of a communication request by call manager 302 can be explained with an exemplary scenario. Assuming that a communication request in form of a VoIP call is received at home communications device 102 from an external device 110a, then the communication request is processed by call manager 302 based on the predefined preferences. The predefined preferences may include rules such as, but not limited to, forward an incoming VOIP call to a mobile phone, or forward an incoming VOIP call to a landline telephone device, or display a video graphics (as a semi-transparent text) from the VOIP call on the television screen, or use an audio system such as home theatre system to generate the audio from the call or use a Bluetooth headset embedded in the TV remote control for the audio of the call and so forth. Moreover, the predefined preferences can be context sensitive to currently playing television program information and a program guide on a television connected to home communications device 102. Further, call manager 302 may determine internal devices 108a-n connected to home communications device 102 before establishing a connection with the call. Accordingly, the incoming call is redirected to an internal device based on the predefined preferences. For example, the call may be redirected to a Bluetooth enabled device that can be used for communication. Further, based on the predefined preferences, call manager 302 can initiate a second call to a telephone of the user and connect the VOIP call to the telephone. In an embodiment of the invention, this may be achieved by using Session Initiation Protocol (SIP) to connect the VOIP call with the landline. Therefore, call manager 302 can process the media format for communication between various media types or communication protocols. Further, call manager 302 may convert Bluetooth events and corresponding data into an appropriate SIP and/or Real-time Transport Protocol (RTP) frame formats such that it seems like standard SIP/RTP data. Moreover, call manager 302 can provide alerts based on the communication.

The call manager can use a Rule-Engine 310 module to process the predefined user preferences. Rule Engine 310 may include set of predefined rules or default rules that may be used to process the user preferences. Further, rule engine 310 may be based on heuristic logic and artificial intelligent inference engine.

The predefined preferences can be configured by the user of internal devices 108a-n. A user manager 304 of communication manager 208 enables the user to configure the predefined preferences. Further, user manager 304 maintains information regarding the user in database 210. For example, the information can be contact information, usage statistics, user information, data such as voicemail, email, channels subscribed by the user, channel viewing data, user profile, log and trace files and so forth. Moreover, user manager 304 can manage a presence status of the user. Examples of presence status include, but are not limited to, available, away, busy, offline, or other custom status values. Further, user manager 304 can set the presence status based on the activity of the user. For example, in case the user is watching a movie on an internal device such as a television, then the presence status may be updated to ‘viewing movie’. Further, the presence status can be shared with other users over the computer network through applications such as Instant Messaging (IM), Short Message Service (SMS), social networking sites such as Twitter, Facebook, Orkut and so forth.

A display manager 306 provides a Graphical User Interface (GUI) for the user. Therefore, the user can configure home communications device 102 and the predefined preferences through the GUI. Display manager 306 may provide a GUI on any display device connected to home communications device 102. For example, the GUI may be displayed on a connected television, a computer screen, a mobile phone screen and so forth. In an embodiment of the invention, display manager 306 provides web based interface to the user. Therefore, the user can remotely configure home communications device 102. Moreover, display manager 306 provides the user with a visual voicemail GUI that allows the user to play existing voice mail messages in any desired order, jump to any part of the played message or skip it altogether, delete messages or save messages. Further, the user can send the messages as e-mail attachments. Moreover, display manager 306 can display the alerts generated by call manager 302. For example, display manager 306 may display a pop-up on an internal device such as television when a call is received. Similarly, alerts may be displayed in case of an email or a voice mail. Further, display manager 306 can display semitransparent messages as popup messages on the screen. It can also create a picture in picture display for video conferencing. Alerts can be for example, in the form of a message displayed on a television screen or a secondary screen, a semitransparent popup message, a Light Emitting Diode (LED) blinking in a specific blinking pattern, an audio sound, and so forth.

Communication manager 208 includes a device manager 308 that manages internal devices 108a-n connected to home communications device 102. Device manager 308 identifies the type and number of internal devices 108a-n connected to home communications device 102. Further, device manager 308 provides the information about internal devices 108a-n to call manager 302, user manager 304 and display manager 306 for proper functioning of communication manager 208. For example, device manager 308 may detect the presence of a mobile phone based on Bluetooth connection. Therefore, display manager 306 can display the presence of the mobile phone on the GUI and enables the user to utilize the device in the predefined preferences. Further, call manager 302 can rout the communication to and/or from the mobile phone based on the availability of the mobile phone. The device manager can also use the Bluetooth profile (such as hands-free car-kit) to download and update user contact information from the cellphone to the database 210 and vice versa. The device manager 308 can populate and synchronize a contact list from an internal device such as the user's cellular phone contact list with other internal devices or home communications device 102 by using the Bluetooth interface, or a contact list from the user's Internet Messenger, Internet Relay Chat (IRC) friends, online game friends, and so forth with other internal devices using a suitable protocol such as TCP/IP.

Communication manager 208 includes rule engine 310 that processes the rules defined by the user preferences as part of the call manager 302 operation. Rule engine 310 may include heuristics and artificial intelligence logic as part of the rule processing functions.

As discussed, communication manager 208 manages various types of communication requests and configuration of home communications device 102. Although not described, a person skilled in the art will appreciate that communication manager 208 can provide other functionalities such as conference calling, instant messaging, video conferencing, voicemail functions and other functionalities to the user. Further, communication manager 208 can download instructions in the home communications device 102. For example, the instructions can be a software update for home communications device 102, communication manager 208, and/or other modules of home communications device 102.

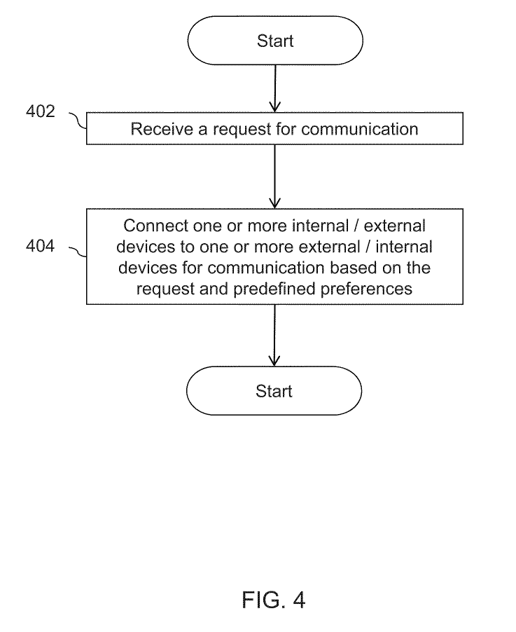

With reference to FIG. 4 a flowchart is illustrated for managing a request for communication, in accordance with an embodiment of the invention. At step 402, a request for communication is received at home communications device 102. In an embodiment of the invention, the request is sent by external device 110a-n for communication with the user at one of the internal devices 108a-n. For example, a person may dial the number that terminates at the home communications device 102 for communication with its user at one of the internal devices. For example, a friend or a family member may call the user through a VOIP trunk to an internal device such as the telephone of the user. Incoming calls can arrive from VoIP trunks or cellular trunks which are connected to home communications device 102 through a Bluetooth radio connection. In another embodiment of the invention, the request is sent from an internal device 108a-n for communication with a person at an external device 110a-n. Thereafter, at step 404, home communications device 102 processes the request for communication and connects the internal device and external device for communication based on the predefined preferences. In another embodiment of the invention an incoming call which arrives from an external device on a VoIP trunk is processed at step 404 by the home communications device 102 and based on the predefined user preferences and rules it is connected to a cell phone trunk, which is used to access the public network. Home communications device 102 may initiate a SIP session to connect the internal and the external devices. Therefore, home communications device 102 may process the media format of communication such as voice, so that communication can be possible across separate communication protocols. For example, VOIP (such as SIP, MGCP or H.323) to radio or analog telecommunication and vice versa.

Further, home communications device 102 may redirect or forward the call based on the predefined preferences and the set of predefined rules. For example, if the request for communication is for a mobile phone number which is not available at that moment, then the call may be automatically redirected to a landline telephone number of that person based on the user's predefined preferences. As a result, unified communications features are provided to the user.

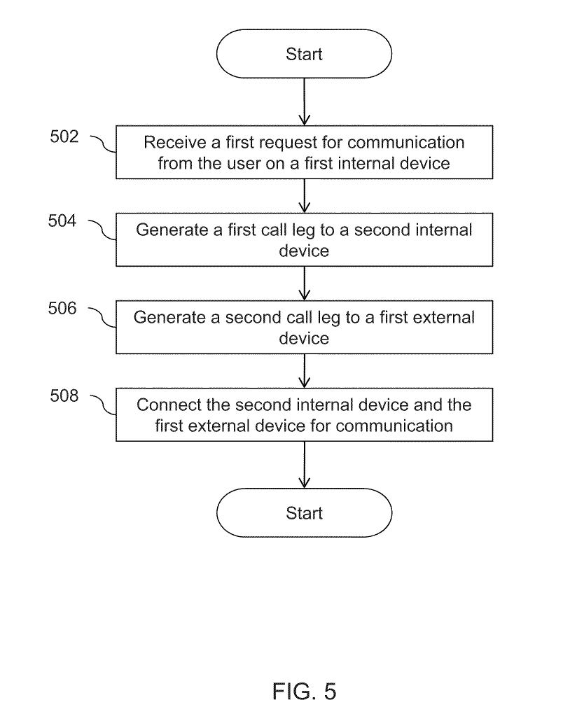

FIG. 5 is a flowchart for managing a request for communication sent by an internal device, in accordance with an embodiment of the invention. As discussed above, one or more devices can connect and communicate through home communications device 102. The user may desire to use one of the available internal devices for connecting a first internal device to a first external device. For example, the user may desire to generate a call by selecting a phone number of an external device or by selecting the name of another person from an address book or a call journal on the TV screen. Alternatively, the user can use a numeric keypad of the remote control of the television for dialing any telephone number.

In this case, at step 502, a first request for communication is received at home communications device 102 from a user by using a first internal device. The first internal device can be any device from internal devices 108a-n, such as a remote control or a telephone. Further, the request may be for connecting and communication with a first external device. Subsequently, at step 504, a first call leg to a second internal device is generated based on the request, the user's choice of which internal device to use and the predefined preferences. For example, the user can select a particular telephone device as second internal device, or the telephone device may be selected as a default based on the predefined preferences.

Thereafter, at step 506, a second call leg to the first external device is generated. In another embodiment of the invention, the first internal device, the second internal device and the first external device have separate communication protocols. Subsequently, at step 508, the second internal device and the first external device are connected for communication.

Further, the user may desire to use his/her cellular phone as a public network access (a trunk). The cellular phone is connected to the home communications device 102 through the Bluetooth protocol. Home communications device 102 converts the call control commands and audio data into Bluetooth commands and data with the appropriate format recognized by the Bluetooth driver. The communication handling is same as discussed, except that the mobile phone line is used for the outgoing call.

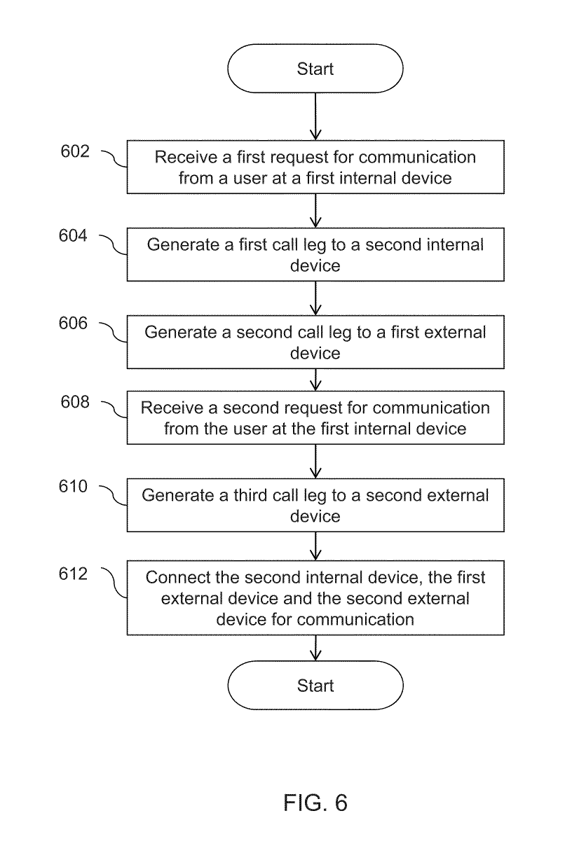

FIG. 6 is a flowchart for managing requests for communication sent by an internal device, in accordance with another embodiment of the invention. The user may desire to communicate with more than one person at the same time (a conference call). In this case, at step 602, a first request for communication may be received at the home communications device 102 from the user by using a first internal device. The first internal device can be any device from internal devices 108a-n. For example, the first internal device may be a remote control that can be used to select contacts displayed on a television screen for calling.

Further, the first request may be for connecting and communication with a first external device. Subsequently, at step 604, a first call leg to a second internal device is generated based on the request and the predefined preferences. For example, the user can select a particular telephone device as the second internal device, or the telephone device may be selected by default based on the predefined preferences.

Thereafter, at step 606, a second call leg to the first external device is generated. At step 608, a second request for communication is received from the user at a first internal device, to add another part to the call. Further, the second request may be for connecting and communication with a second external device. Subsequently, at step 610 a third call leg to the second external device is generated. In an embodiment of the invention, one or more of the second internal device, the first external device, and the second external device may have separate communication protocols. Subsequently, at step 612, the second internal device, the first external device and the second external device are connected in a conference call for communication with each other. A person skilled in the art will appreciate that any number of external devices can be connected as discussed above. Moreover, the person can use the first internal device to communicate with the first external and the second external devices, without using the second internal device. Further, the first device can send the first request and the second request for communication simultaneously or separately. Moreover, as discussed in conjunction with FIG. 5, cellular trunk may be used to communicate among the devices.

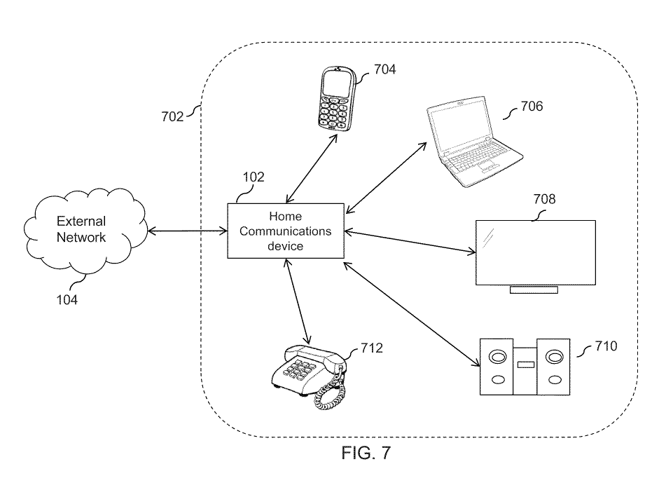

With reference to FIG. 7 an exemplary residential implementation of home communications device 102 in a residential environment 702 is illustrated. As shown, home communications device 102 is connected to external network 104. External network 104 may include a service provider of high bandwidth network and services such as video streaming and television programming, VoIP telephony, and wideband Internet connectivity. Further, external network 104 may include PSTN, private networks and/or mobile cellular networks. In an embodiment of the invention, home communications device 102 may be implemented as enhanced set of software applications and/or middleware with Software Development Kits (SDKs) running on devices such as home media gateway, a DVR, a set-top box/unit and so forth.

Home communications device 102 can be connected to internal devices 108a-n, which include a mobile phone 704, a computing device 706 such as a laptop or tablet pc or PDA, a display device 708 such as a large screen TV or an Internet connected device such as commercially available Sony DASH™ Personal Internet Viewer, an audio system 710 and a telephone 712. Home communications device 102 can be connected to a mobile phone 704 through a wireless Bluetooth connection. Further, home communications device 102 may support Bluetooth profiles, such as a headset profile for connecting with headsets and handsets, and a hands-free profile for connecting with the mobile phone 704 to be used as a cellular trunk line.

A computing device 706 such as a laptop, a computer, a Personal Desktop Assistant (PDA), a tablet computer, a personal Internet viewer and so forth can be connected to home communications device 102. In this case they can be used as a second display in addition to the television screen for display of communication related messages and popup messages and control purposes. Computing device 706 can be connected through various interfaces such as RJ 45 ports, wireless ports and so forth.

A display device 708 such as a large screen LCD or Plasma television can be connected to home communications device 102 for services such as television channels and all GUI display purposes. Further, audio system 710 such as a home theatre system may be connected to home communications device 102 for high quality audio playing. Display device 708 and audio system 710 may be connected through various means such as, but not limited to, a direct HDMI connector, a networking protocol to a remote display adaptor in multi-television configurations such as the DLNA and Universal Plug-n-Play protocols, wireless, twisted pair or co-axial cables within the home and so forth.

Home communications device 102 can be directly connected to a telephone 712 through interfaces such as RJ11 or connected over the home LAN through a Telephony Integrated Device (TAD/IAD). Telephone 712 may be a wired phone or a Digital Enhanced Cordless Telecommunications (DECT) portable telephone or similar technologies such as 5.8 Mhz portable phones. Although not shown here, home communications device 102 may be connected to other devices such as a camera, a microphone, a gaming console, a keyboard and so forth through interfaces such a USB, Bluetooth, infrared, wireless etc. As a result, a unified communications system is provided in a residential environment 702, where the devices connected to home communications device 102 can communicate with each other and with devices across external network 104.

A person skilled in the art will appreciate that residential environment 702 may include implementation in other environments such as commercial, enterprise or business environments as well.

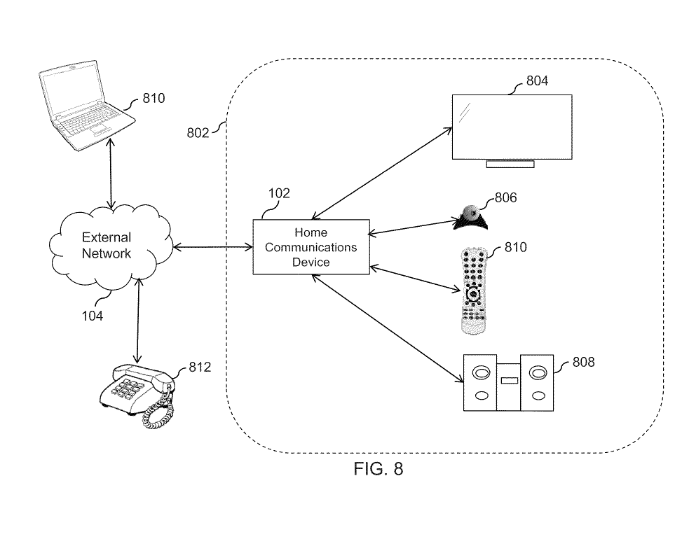

FIG. 8 illustrates an exemplary functional implementation of home communications device 102 in a residential environment 802. As discussed above, internal devices 108a-n can communicate with external devices 110a-n. In this exemplary case, a VOIP video call is received from an external device such as a computing device 810 or a telephone 812 at home communications device 102.

Typically, a VOIP video call includes media such as audio and video. Therefore, when the call is received at home communications device 102, then predefined preferences set by the user are determined. Thereafter, based on the predefined preferences which include the type of the TV program being watched (accessible from the embedded program guide) the VOIP video call may be processed by home communications device 102. As shown with reference to FIG. 8, the video of the VOIP call is displayed on a display device 804 either full screen or as a picture in picture such as a television or a second display device. The audio is presented through an audio system 808 such as a home theatre system. Audio system 808 may also take audio inputs from the user. A USB camera 806 connected to home communications device 102 may be used to provide video and audio (through its integrated microphone) of the user to home communications device 102. A television remote control with an integrated Bluetooth headset 810 can be used as an audio device connected to home communications device 102. Therefore, a high quality unified communication experience is provided to the user.

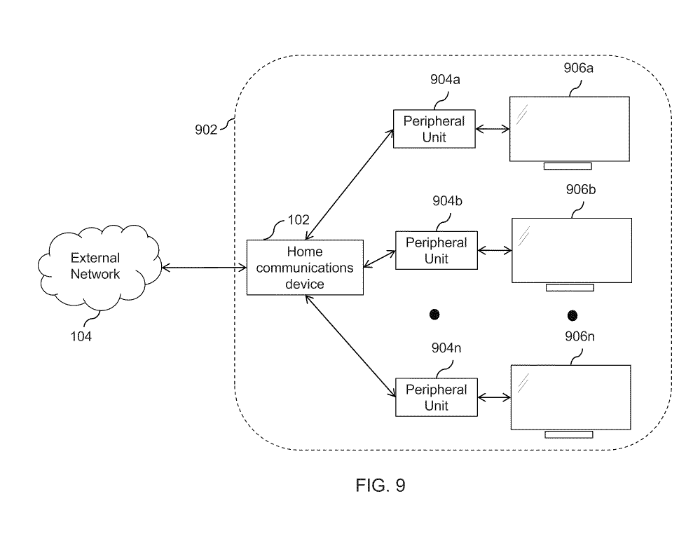

With reference to FIG. 9 another exemplary residential implementation of home communications device 102 in a residential environment 902 is illustrated. As shown, a home communications device 102 is connected in a home with multiple TV sets to a low-cost peripheral unit 904a which is in turn connected to a television 906a. Similarly, home communications device 102 is connected to other peripheral units 904b-n which are in turn connected to a televisions 906b-n.

In this case, peripheral units 904a-n may be low functionality, low cost set-top boxes that provide video and audio and remote control features to televisions 906a-n. Peripheral units 904a-n can be connected to home communications device 102 over twisted pair or cable wiring, home power-lines or over wireless connectivity such as 802.11n, using protocols such as Multimedia over Coax Alliance (MoCA), Home Phone-line Networking Alliance (HomePNA), G.hn, Digital Living Network Alliance (DLNA), and so forth. Further, home communications device 102 may be an enhanced DVR that provides advanced functionalities such as television program recording, pausing, forwarding, broadband connection and telephony connectivity and so forth. Home communications device 102 includes the computational power to run advanced software applications such as the unified communications features described in this invention disclosure. Therefore, when multiple television sets are required in a particular environment such as residential environment 902, only a single home communications device 102 may be implemented. As a result, advanced functionalities can be provided to the users of televisions 906a-n. For example, the user can put a video call on hold on peripheral unit 904a and television 906a goes to another room, where peripheral unit 904b and television 906b are and continue the call from there. Further, a user of television 906a can communicate with another user of television 906b. For example, the user of television 906a can send an instant message to another user of television 906b. Further, cheap and/or low functionality peripheral units 904a-n can be used. As a result, the cost of implementation of multiple televisions in a single environment is reduced.

Moreover, although not shown, home communications device 102 can be used to connect other devices as discussed above. As a result, the experience of the user is further enhanced.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions which execute on the computers or other programmable data processing translator create means for implementing the functions specified in the block or blocks. Such computer program instructions may also be stored in a computer-readable memory or computer program products that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical in various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, smart phones, multiprocessor systems, microprocessor-based or programmable consumer electronics, network PCs, minicomputers, mainframe computers, set-top boxes, DVRs, HMGWs and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A home communications device connected to an external network, wherein the external network comprises one or more external devices, the home communications device comprising:
a plurality of interfaces for connecting the home communications device to a plurality of internal devices to form an internal network; and
a communication manager configured to enable communication among a plurality of the internal devices and the external devices, wherein one or more of the internal devices and the external devices operate on similar or separate communication protocols.

2. The home communications device of claim 1, wherein the internal devices comprise one or more of telephones, televisions, and computers.

3. The home communications device of claim 1 comprises at least one of a digital video recorder, a set-top box, a smart-television, a blu-ray player device, a game console unit, a media streaming device, an integrated telephony access device and a home media gateway.

4. The home communications device of claim 1, wherein the external network comprises at least one of a high-bandwidth computer network, a cable infrastructure, a satellite infrastructure and a telephone network

5. The home communications device of claim 1, wherein the communication protocols comprise at least one of the Internet Protocol, Real-time Transport Protocol, Session Initiation Protocol, H.323 or MGCP protocols, Digital Enhanced Cordless Telecommunications, Bluetooth and cellular telecommunication.

6. The home communications device of claim 1, wherein the communication manager enables the communication based on at least one or more predefined preferences and one or more predefined set of rules.

7. The home communications device of claim 6, wherein the predefined preferences comprise routing a Voice Over Internet Protocol call to a telephone.

8. The home communications device of claim 6, wherein the predefined preferences comprise routing a Voice Over Internet Protocol call to a mobile phone.

9. The home communications device of claim 6, wherein the predefined preferences comprise routing a cellular call to at least one of a VoIP call, a landline telephone, and a Bluetooth enabled internal device.

10. The home communications device of claim 1, wherein the communication manager is further configured to:
receive a first request for communication from a first internal device of the internal devices;
generate a first call leg to a second internal device of the internal devices based on one or more predefined preferences;
generate a second call leg to a first external device of the external devices; and
connect the second internal device and the first external device for communication.

11. The home communications device of claim 10, wherein the communication manager is further configured to:
receive a second request for communication from the first internal device;
generate a third call leg to a second external device of the external devices based on the one or more predefined preferences; and
connect the second internal device, the first external device and the second external device for communication in a conference call.

12. The home communications device of claim 1, wherein the communication manager is further configured to:
receive a first request for communication from a first external device of the external devices;
generate a first call leg to a first internal device of the internal devices based on one or more predefined preferences;
connect the first internal device and the first external device for communication.

13. The home communications device of claim 1, wherein the internal device is selected based on one or more predefined preferences.

14. The home communications device of claim 1, wherein the communication manager comprises one or more of a Graphical User Interface (GUI), a set of rule wizards and a plurality of video clips.

15. The home communications device of claim 1, wherein the communication manager is configured to store communication data, and wherein the communication data comprises one or more of voice mails, e-mails, messages, contact information, network statistics, call journal records, trace records, predefined preferences, and user profiles.

16. The home communications device of claim 1, wherein the communication manager is further configured to manage a presence status of a user.

17. The home communications device of claim 1, wherein the communication manager is configured to use predefined set of rules to process one or more predefined preferences.

18. The home communications device of claim 17, wherein the predefined preferences are context sensitive to a currently playing television program information and a program guide.

19. The home communications device of claim 1, wherein the communication manager is further configured to populate and synchronize one or more contact lists between the home communications device and the one or more internal devices.

20. A method for managing communications at a home communications device, wherein the home communications device is connected to an external network and an internal network, the method comprising:
receiving a first request for communication at the home communications device; and
connecting, by the home communications device, one or more external devices to one or more internal devices for communication based on the request and one or more predefined preferences, wherein the internal devices are connected to the internal network and the external devices are connected to the external network, and wherein one or more of the internal devices operate on similar or separate communication protocols.

21. The method of claim 20, wherein the first request is sent by a first internal device of the internal devices connected to the internal network.

22. The method of claim 20, wherein the connecting by the home communications device comprises:
generating, by the home communications device, a first call leg to a second internal device of the internal devices based on one or more predefined preferences;
generating, by the home communications device, a second call leg to a first external device of the external devices; and
connecting, by the home communications device, the second internal device and the first external device for communication.

23. The method of claim 22, further comprising:
receiving a second request for communication from the first internal device;
generating a third call leg to a second external device of the external devices; and
connecting the second internal device, the first external device and the second external device for communication for conferencing.

24. The method of claim 20, wherein the connecting by the home communications device comprises:
receiving a first request for communication from a first external device of the external devices;
generating a first call leg to a first internal device of the internal devices based on one or more predefined preferences;
connecting the first internal device and the first external device for communication.

25. The method of claim 20, further comprising managing a presence status of a user by the home communications device.

26. The method of claim 20, further comprising providing by the home communications device one or more alerts based on the communication.

27. A computer program product comprising instructions executable by a processor to perform a method for managing communications at a home communications device, wherein the home communications device is connected to an external network and an internal network, the method comprising:
receiving a first request for communication at the home communications device; and
connecting, by the home communications device, one or more external devices to one or more internal devices for communication based on the request and one or more predefined preferences, wherein the internal devices are connected to the internal network and the external devices are connected to the external network, and wherein one or more of the internal devices operate on similar or separate communication protocols.

28. The computer program product of claim 27, wherein the first request is sent by a first internal device of the internal devices connected to the internal network.

29. The computer program product of claim 27, wherein the connecting by the home communications device comprises:
generating, by the home communications device, a first call leg to a second internal device of the internal devices based on one or more predefined preferences;
generating, by the home communications device, a second call leg to a first external device of the external devices; and
connecting, by the home communications device, the second internal device and the first external device for communication.

30. The computer program product of claim 29, wherein the method further comprises:
receiving a second request for communication from the first internal device;
generating a third call leg to a second external device of the external devices; and
connecting the second internal device, the first external device and the second external device for communication in a conference call.

31. The computer program product of claim 29, wherein the connecting by the home communications device comprises:
receiving a first request for communication from a first external device of the external devices;
generating a first call leg to a first internal device of the internal devices based on one or more predefined preferences; and
connecting the first internal device and the first external device for communication.

32. The computer program product of claim 29, wherein the method further comprising downloading the instructions in the home communications device.
